(19) United States
(12) Patent Application Publication
(10) Pub. No.: US 2005/0005460 A1
(43) Pub. Date: Jan. 13, 2005

(54) Apparatus for engraving images and its adaptor

(76) Inventor: Yuichi Hoshiyama, Sapporo City (JP)

Correspondence Address: WENDEROTH, LIND & PONACK, L.L.P., 2033 K STREET N. W., SUITE 800, WASHINGTON, DC, 20006-1021, US

(21) Appl. No.: 10/900,330

(22) Filed: Jul. 28, 2004

Related U.S. Application Data
(63) Continuation of application No. 09/950,178, filed on Sep. 10, 2001.

(30) Foreign Application Priority Data
Sep. 12, 2000 (JP) 318605/2000

(51) Int. Cl. G01D 21/00

(52) U.S. Cl. 33/13

(57) ABSTRACT

An apparatus for engraving images on a passport, credit card, identification card, or the like, and its adaptor for use in the apparatus, the apparatus comprising a personal computer, a controller, a vibration-preventing unit, an X axis pulse motor driver, a Y axis pulse motor driver, an X axis pulse motor., a tilt motor driver, a Z axis head motor having a minute ΔY axis driver, a stylus and a vacuum pump whereby photographs of faces, addresses, names, autographs, the images for engraving information identifying one's identity, the images from a digital camera, scanner or other information taken from a computer through a network can be automatically and correctly engraved on identification cards such as passports, drivers' licenses, employee certificates or credit cards.

### BACKGROUND OF THE INVENTION

1. Field of the Invention

This invention relates to an apparatus for engraving images and its adaptor, and more particularly, an apparatus for engraving images such as photographs of faces, addresses, names, autographs, the images for engraving information identifying one's identity, the images from a digital camera, scanner or other information taken from a computer through a network on identification cards such as passports, drivers' licenses, employee certificates or credit cards, and its adaptor.

2. Description of the Prior Art

There have been proposed various engraving apparatuses (for example, U.S. Pat. No. 5,232,231, Japanese Patent publication Nos. 115676/1989, No. 201762/1988).

According to the conventional apparatus for engraving images on the passports, driver's licenses, employee certificates or credit cards, a magnetic layer is coated on a surface of a plastic card or synthetic paper, and if necessary, a given thin colored layer is coated on a surface of the magnetic layer or synthetic paper, on which a given magnetic picture or image is engraved by a cutting head or a stylus.

When making the passports, driver's licenses, employee certificates or credit cards, the photographs of faces, addresses, names, autographs, the images for engraving information identifying one's identity, etc. are engraved on them together with the position, ID number etc. in order to increase the security of the engraved cards and to avoid their forgery.

Engraving data source can be roughly classified into image data and text data, which are displayed on a personal computer as independent data, and if necessary, they are combined in the personal computer.

In accordance with the conventional engraving apparatus, independent character data and independent image data are inputted by an independent controller.

In addition, it takes a long time and costs much to develop software and data, and it is also necessary for a user to get used to the method of using the conventional engraving apparatus, thus increasing burden of the user and making it difficult to transmit, edit and compress the data and causing much confusion and trouble.

The biggest disadvantage of the conventional engraving apparatus is that when making a personal card, it requres to make engraving apparatus file data such as a face picture, address, name, or autograph of one person independently and to designate all of the files and to collect and integrate the data.

For the media engraving data such as a face picture, address, name, autograph and the images for engraving information identifying one's identity, etc., there are plastic cards in addition to the magnetic or non-magnetic cards.

There are a lot of kinds of the magnetic, non-magnetic cards or plastic cards such as standard sized, large-sized, passport size and other sized cards.

Accordingly, it needs to make a lot of kinds of the expensive engraving apparatuses in accordance with these media and their property.

Further, it is likely that vibrations of an engraving head of the conventional engraving apparatus oscillate the engraving apparatus itself to cause incorrect engraving.

### SUMMARY AND OBJECTS OF THE INVENTION

A principal object of this invention is to provide an apparatus for engraving images which comprises a personal computer, a controller, an X-axis pulse motor driver, a Y-axis pulse motor driver, an X-axis pulse motor, a tilt motor driver, a Z-axis head motor having a minute ΔY-axis driver, a stylus and a vacuum pump whereby photographs of faces, addresses, names, autographs, the images for engraving information identifying one's identity, the images from a digital camera, scanner or other information taken from a computer through a network can be automatically and correctly engraved on identification cards such as passports, drivers' licenses, employee certificates or credit cards.

Another object of this invention is to provide an apparatus for engraving images whereby a side-by-side comparison of the original image with an engraved image is not required for an operator so that erroneous inputting of information or wrong engraving of another person can be substantially avoided.

Another object of this invention is to provide an apparatus for engraving images comprising a vibration-preventing unit whereby smooth and correct engraving can be easily carried out without causing vibration.

Another object of this invention is to provide an apparatus for engraving images, which is simple in construction so as to facilitate easy assembly, operation and maintenance.

Another object of this invention is to provide an apparatus for engraving images for a passport, identity card and the like whereby various kinds of adaptors are prepared in advance in order to exchange the desired adaptors without making various kinds of the apparatus for engraving images.

Another object of this invention is to provide an adaptor for use in an apparatus for engraving images on identification cards, which comprises a rectangular table having a positioning groove and a ridge, both being provided around and near a peripheral edge portion thereof, and a plurality of small air openings provided at the given positions through the table whereby an engraved medium can be sucked and located on the table correctly.

Still another object of this invention is to provide an adaptor for use in an apparatus for engraving images which comprises a first rectangular table including a second rectangular table which is rigidly secured at a given obtuse angle to the first rectangular table, and a third rectangular table which is pivotally connected to the second rectangular table so that an engraved medium can be sucked and located on the table correctly.

These and other advantages of the invention will become more apparent from the following detailed description thereof when taken in conjunction with the accompanying drawings.

### BRIEF DESCRIPTION OF THE DRAWINGS

FIG. 1 is a perspective view of an embodiment of an apparatus for engraving images or information identifying one's identity on a passport, or the like of this invention;

FIG. 2 is a schematic front view of the apparatus for engraving images shown in FIG. 1;

FIG. 3 is an enlarged schematic perspective view of an apparatus for engraving images shown in FIGS. 2 and 3;

FIG. 4 is an enlarged schematic front view of a driving unit of the apparatus having a vibration-preventing unit and an X-axis feeder shown in FIGS. 2 and 3;

FIG. 5 is an enlarged schematic sectional view showing the sucking relationship between an X-axis feeder, an adaptor and an engraved medium shown in FIG. 4;

FIG. 6 is a schematic block diagram of an apparatus for engraving images;

FIG. 7 is a schematic front perspective view of an adaptor described in claim 2;

FIG. 8 is a schematic perspective view of an adaptor shown in FIG. 7, seen from a backside;

FIG. 9 is a schematic perspective view of an adaptor described in claim 3, showing that a third rectangular table is pivotally opened from to the second rectangular table;

FIG. 10 is a schematic perspective view of an adaptor shown in FIG. 9, seen from a backside; and

FIG. 11 is a schematic perspective view showing that a passport is held between the second and third rectangular tables.

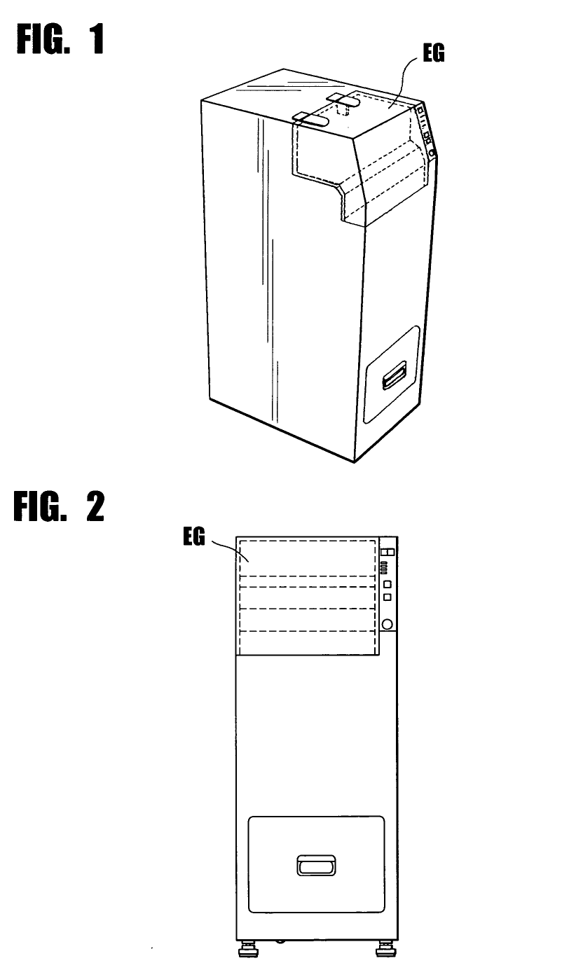

### DETAILED DESCRIPTION OF THE PREFFERRED EMBODIMENT

Referring to the accompanying drawings in which like numerals designate the like parts throughout the several views thereof, this invention will be explained to an example of an apparatus EG for engraving images is connected to a personal computer PC.

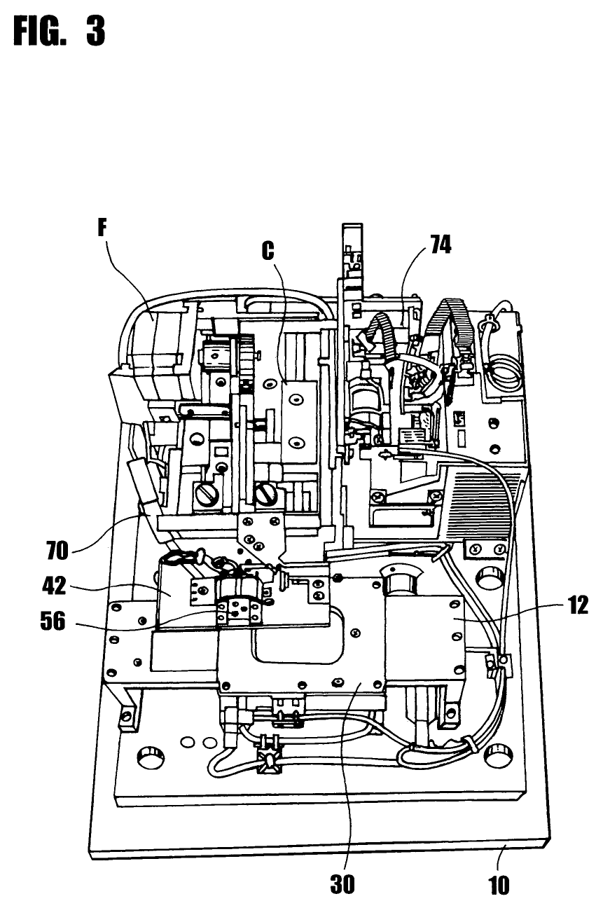

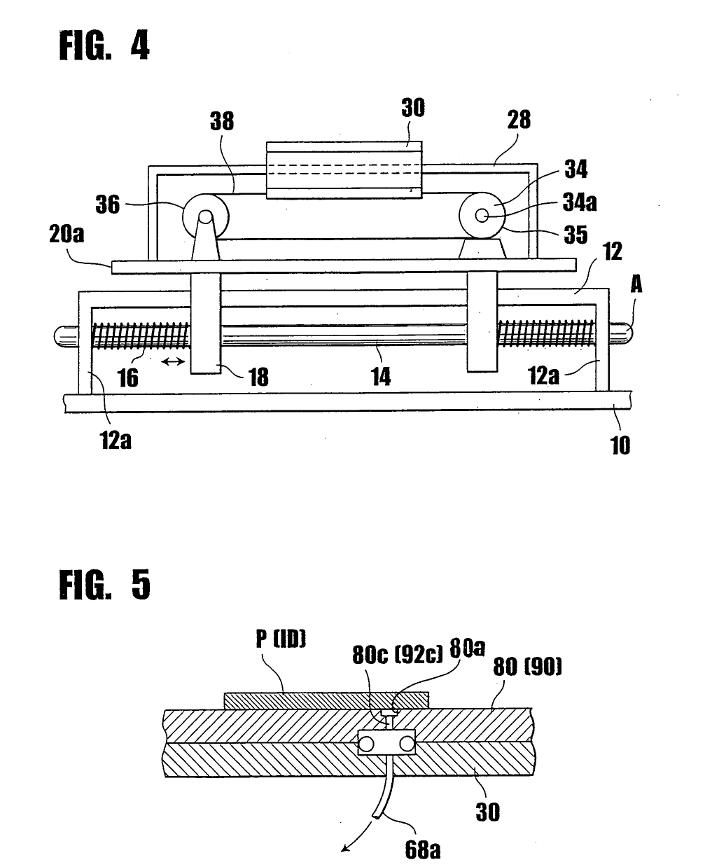

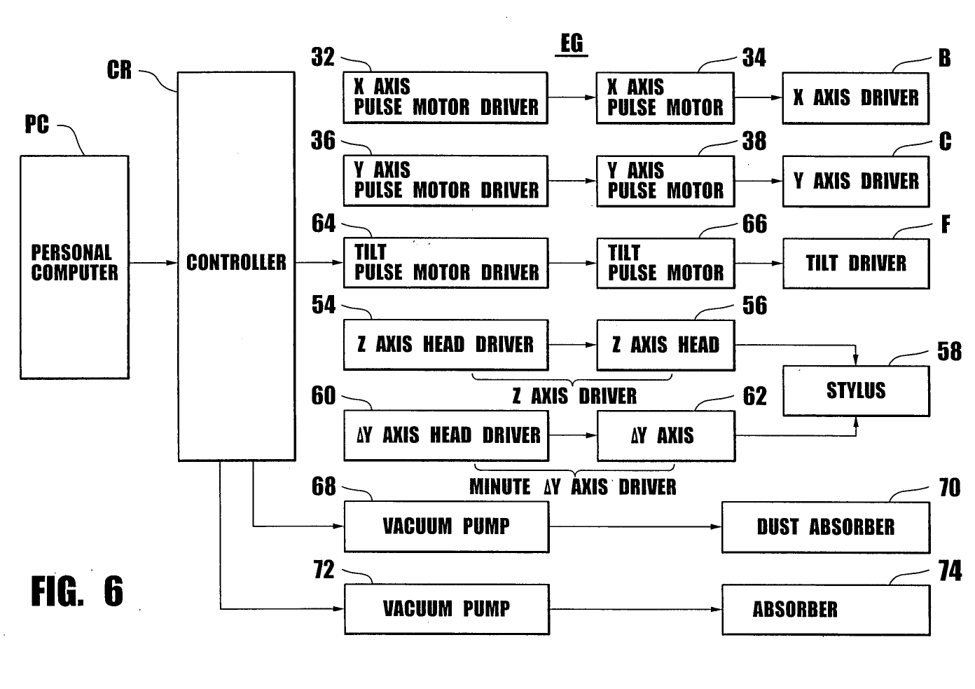

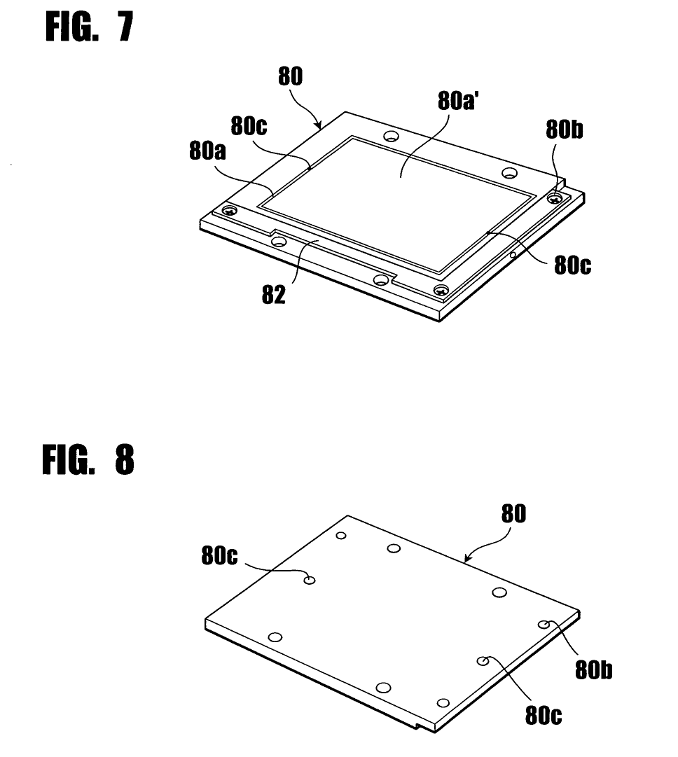

As particularly shown in FIGS. 2-6, the apparatus EG comprises a base plate 10 having a given thickness and a width, on which a Π-shaped driving stand 12 having a pair of legs 12a, 12a is rigidly mounted.

An opening (not shown) is provided through a central portion of the leg 12a, and a pair of bearings 18, 18, each having an opening (not shown), are made independently.

Both end portions of a spindle 14 is penetrated through the openings of the bearings 18, 18 and the openings of the legs 12a, 12a with a pair of coil springs 16, 16, each being located between the leg 12a and the bearing 18 respectively.

It should be appreciated that the spindle 14 is mounted to extend horizontally and in parallel with the base plate 10 to form a vibration-preventing unit A.

A second base plate 20a is integrally mounted on the top of each bearings 18, 18, a pair of driving and driven pulleys 36 and 34 are provided on a pair of blocks mounted on the second base plate 20a, a timing belt 38 is engaged on these pulleys 36 and 34, an X-axis feeder 30 is provided on the timing belt 38 and a Π-shaped rail 28, and an X-axis pulse motor driver 32 and an X-axis pulse motor 34 are connected to the X-axis feeder 30.

A Y-axis driver C that is connected to the controller CR of the engraving apparatus EG comprises a Y-axis pulse motor driver 36 and an X-axis pulse motor 38.

A Z-axis driver D is provided on a head base, which is a top portion of the Y-axis driver C.

The Z-axis driver D comprises a Z-axis head driver 54, a Z-axis head 56, a stylus 58 provided at a lower portion of the Z-axis head 56, and a minute ΔY-axis driver E having a Y-axis head driver 60 and a ΔY-axis head 62 is connected to the stylus 58.

A Y-axis driver F which is connected to the controller CR comprises a tilt pulse motor driver 64 and a tilt pulse motor 66 which is provided at a front portion of the Y-axis driver C so that when an adaptor 80 is tilted rearwards, an engraved media such as a passport P or an identification card ID can be easily placed on the adaptor 80.

Mounted on the adaptor 80 and near the X-axis pulse motor 34 is a vacuum pump 68, an air hose 68a having a small diameter which is mounted to locate near the X-axis pulse motor 34 to work as a dust absorber 74 of the engraved cut dust or scrap.

As shown in FIGS. 5-8, an adaptor 80 described in claim 2 includes a rectangular table having a given thickness and width, and it can be put on the feeder 30.

As particularly shown in FIGS. 7 and 8, another end portion of the air hose 68a is put into the air opening 80c from a backside of the positioning rectangular groove 80a is provided near an outer periphery of the adaptor 80, a rectangular plane 80a′ which is defined by the rectangular groove 80a is dented slightly for about 0.1 mm, and a pair of small air openings 80c, 80c are provided through the adaptor 80 to locate at the upper and lower grooves 80a, 80a, thus absorbing air from backside to hold the media such as an identification card ID on the rectangular dent rectangular portion 80a′

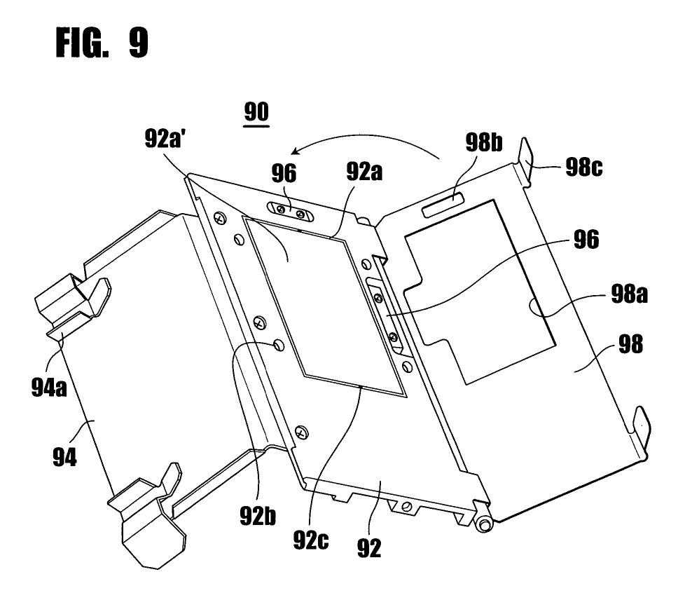

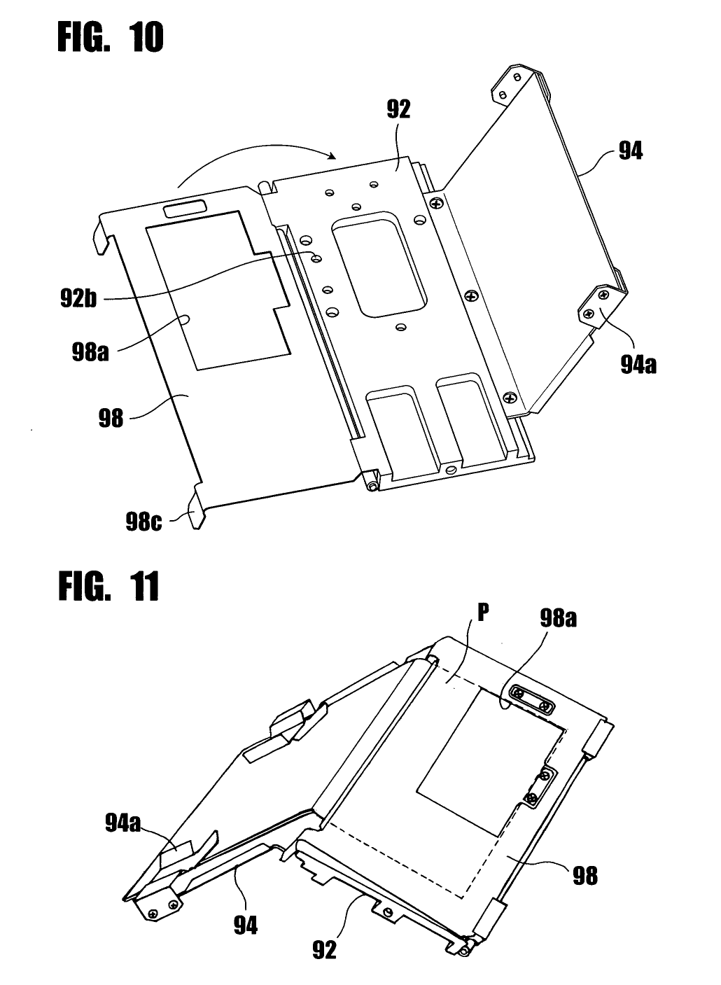

An adaptor 90 in claim 3 for engraving images on a passport P is shown in FIGS. 9-11, in which the adaptor 90 has a holding table 92 and an inclined table 94 which is rigidly secured to an one edge portion of the holding table 92 and a lid plate 98 which is pivotally secured to another edge portion of the inclined table 94.

More particularly, the holding table 92 has a given thickness and width, a rectangular plane 90a′ which is defined by the rectangular groove 90a is dented slightly for about 0.1 mm, and a pair of small air openings 90c, 90c are provided through the adaptor 90 to locate at the upper and lower grooves 90a, 90a, thus absorbing air from backside to hold the engraved passport P on the rectangular dent portion 90a′.

In addition, a pair of positioning ridges 96, 96 are provided on a top and a side portions of the holding table 92, and a rectangular window 98a is provided through the lid plate 98 in order to correspond with the rectangular dent portion 90a′.

A pair of clips 94a, 94a are provided at both corner portions of the inclined table 94, and a pair of grips 98c, 98c are mounted at both upper and lower portions of an outer edge portion of the lid plate 98 so that the engraved passport P may be correctly held between the holding table 92 and the lid plate 98 and smooth engraving can be easily carried out without causing vibration.

As explained in the foregoing paragraphs and as particularly shown in FIGS. 7-11, the rectangular plane 80a′ which is defined by the rectangular groove 80a is dented slightly for about 0.1 mm, and a pair of the small air openings 80c, 80c are provided through the adaptor 80 to locate at the upper and lower grooves 80a, 80a so that the media such as an identification card ID can be easily positioned on the rectangular dent rectangular portion 80a′ and held on the adaptor 80 by a negative pressure of air.

It should be appreciated that a suction pump, a pressure sensor, an electromagnetic valve and a piping (not shown) are connected to the air hose 68a.

Like the example of the adaptor 80, the adaptor 90 for engraving images on a passport P comprises the rectangular plane 90a′ which is defined by the rectangular groove 90a and is dented slightly for about 0.1 mm, and a pair of small air openings 90c, 90c are provided through the adaptor 90 to locate at the upper and lower grooves 90a, 90a so that the engraved passport P can be disposed on the rectangular dent portion 90a′ to allow a correct and smooth engraving of the engraved passport P.

### MODE OF OPERATION

The apparatus EG for engraving images on a passport, identification card, or the like is connected to the personal computer PC, an engraved media such as a magnetic card is manually put on the adaptors 80 (or 90), which is mounted on the X-axis feeder 30, into which the images such as a picture of face, name, autograph, information identifying one's identity, etc. or other information data taken from a digital camera, scanner, or other computers through a network are transmitted by an image signal from the controller CR to make the stylus 58 to be reciprocated rapidly right and left (in a direction of the X-axis), back and forth (in a direction of the Y-axis) and up and down (in a direction of the Z-axis) to engrave the desired images on the media such as a passport, identification card, or the like into a converted depth.

Other modifications can be made to this invention by those skilled in the art without departing from the scope thereof. While several forms of the invention have been illustrated and described, it will also be apparent that various modifications can be made without departing from the spirit and scope of the invention. Accordingly, it is not intended that the invention be limited, except as by the appended claims.

1. An apparatus for engraving images which comprises;
a controller connected to a personal computer;
a base plate having a given thickness and a width, on which a Π-shaped driving stand having a pair of legs is rigidly mounted, said each leg having an opening provided through a central portion thereof;
a spindle being penetrated through the openings of said bearings with a pair of coil springs to extend horizontally and in parallel with the base plate to form a vibration-preventing unit, each coil spring being located between said leg and a pair of bearings mounted slidably on said spindle to reciprocate;
a second base plate integrally mounted on the top portion of each bearings;
a pair of driving and driven pulleys provided on a pair of blocks mounted on the second base plate;
a timing belt engaged on said pulleys;
an X-axis feeder provided on said timing belt and said Π-shaped rail;
an X-axis pulse motor driver and an X-axis pulse motor connected to said X-axis feeder;
a Y-axis driver connected to the controller;
a Y-axis pulse motor driver connected to the an X-axis pulse motor;
a Z-axis driver provided on a head base, which is a top portion of the Y-axis driver;
a Z-axis driver including a Z-axis head driver and a Z-axis head;
a stylus provided at a lower portion of the Z-axis head;
a minute ΔY-axis driver having a Y-axis head driver and a ΔY-axis head connected to said stylus; and
a Y-axis driver comprising a tilt pulse motor driver and a tilt pulse motor disposed at a front portion of the Y-axis driver in such a manner that when an adaptor is tilted rearwards, an engraved media such as a passport P or an identification card ID can be easily placed on the adaptor.

2. An adaptor for use in an apparatus for engraving images as claimed in claim 1, which comprises a rectangular table having a given thickness and width and being put on the feeder, said rectangular table having a positioning rectangular groove provided near an outer periphery of the said rectangular plane which is defined by the rectangular groove and dented slightly for about 0.1 mm, a pair of small air openings provided thorough the adaptor to locate at the upper and lower grooves, an air hose being disposed at a backside of said table, one end portion of said air hose being put into the air opening from a backside and another end being connected to a vacuum pump in order to hold an identification through a negative pressure of air.

3. An adaptor for use in an apparatus for engraving images on a passport as claimed in claim 1, which comprises a rectangular table, a holding table and an inclined table which is rigidly secured to an one edge portion of the holding table and a lid plate which is pivotally secured to another edge portion of the inclined table, said holding table having a given thickness and width, said rectangular plane being defined by the rectangular groove and being dented slightly for about 0.1 mm, a pair of small air openings being provided through the adaptor to located at the upper and lower grooves, thus absorbing air from backside to hold the engraved passport P on the rectangular dent portion, a pair of positioning ridges being provided on a top and a side portions of the said holding table, a rectangular window being provided through the lid plate in order to correspond with the rectangular dent portion, a pair of clips being provided at both corner portions of the inclined table, and a pair of grips being mounted at both upper and lower portions of an outer edge portion of the lid plate so that the engraved passport may be correctly held between the holding table and the lid plate and smooth engraving can be easily carried out without causing vibration.

4. An adaptor for use in an apparatus for engraving images on a passport as claimed in claim 1, which comprises a rectangular table, a holding table and an inclined table which is rigidly secured to an one edge portion of the holding table and a lid plate which is pivotally secured to another edge portion of the inclined table, said holding table having a given thickness and width, said rectangular plane being defined by the rectangular groove and being dented slightly for about 0.1 mm, a pair of small air openings being provided through the adaptor to located at the upper and lower grooves, thus absorbing air from backside to hold the engraved passport P on the rectangular dent portion, a pair of positioning ridges being provided on a top and a side portions of the said holding table, a rectangular window being provided through the lid plate in order to correspond with the rectangular dent portion, a pair of clips being provided at both corner portions of the inclined table, and a pair of grips being mounted at both upper and lower portions of an outer edge portion of the lid plate so that the engraved passport may be correctly held between the holding table and the lid plate and smooth engraving can be easily carried out without causing vibration.
